(19) United States
(12) Patent Application Publication
(10) Pub. No.: US 2016/0299571 A1
(43) Pub. Date: Oct. 13, 2016

(54) CONTROL SYSTEM FOR ELECTRONIC DEVICE

(71) Applicant: SWIMMO INC., DOVER, DE (US)

(72) Inventors: Tomasz Watorowski, Poznan (PL); Mateusz Heleniak, Poznan (PL)

(21) Appl. No.: 15/085,583

(22) Filed: Mar. 30, 2016

Related U.S. Application Data
(60) Provisional application No. 62/145,605, filed on Apr. 10, 2015.

(51) Int. Cl. G06F 3/01

(52) U.S. Cl. CPC G06F 3/017; G06F 3/014

(57) ABSTRACT

Provided herein are systems and methods directed to using motion to issue input control commands to control a device. In particular, the systems and methods disclose providing tap motion and/or rotational motion input at a human interface device, such input being sensed by one or more gyroscopic sensors and/or accelerometers, which in turn transmit an input signal that correlates to the direction and/or magnitude of the input to a processor. The processor executes program code to modify and/or accept data values relating to active commands presented by a user interface at the display in response to the input signals sent by the one or more sensors.

### CROSS REFERENCE TO RELATED APPLICATION

The present application is related to and claims the benefit of U.S. Provisional Patent Application Ser. No. 62/145,605 entitled “CONTROL SYSTEM FOR WRIST MOUNTED ELECTRONIC DEVICE” and filed on Apr. 10, 2015, the entire contents of which are incorporated by reference as if set forth in its entirety herein.

### FIELD OF THE INVENTION

The invention described herein generally relates to systems, methods and computer program products for using various motions to issue input control commands to control a device. In particular, the invention relates to systems, methods and computer program products for providing input as one or more motion-based control commands by receiving output from gyroscopic and/or accelerometer type sensors and executing program code in response. The execution of program code allows a processor to process data acquired from such sensors to determine whether tap or rotational gestures were performed and to interact with or otherwise accordingly update user interface elements.

### BACKGROUND OF THE INVENTION

While electronic devices have become popular in conjunction with diet and exercise regimens, such as through monitoring physiological functions during exercise, several drawbacks have been encountered in view of the miniaturization of input controls, as well as the necessity to position input controls in close proximity to one another due to the limited available display space. Occasional requirements to actuate or depress several controls simultaneously is a complicated task that further compounds these problems. Thus, it is extremely difficult during an exercise routine to vary a given operational function of, for example, exercise programs, watch functions, goals, types of workouts, distance traveled, speed/pace, duration of activity, heartrate, calories burned, blood pressure, heart rate zones, etc.

### SUMMARY OF THE INVENTION

Embodiments of the invention are directed towards systems, methods and computer program products for providing motion-based input control via one or more motion sensors. In accordance with one embodiment, the invention is directed towards a method for motion-based input control for a device. For example, the device can be a wrist-mounted exercise monitor that comprises one or more motion sensors disposed within a housing, the housing being joined coplanar to a flexible strap that has a first end and a second end that couples to the first end in a removable fashion to thereby define a closed loop having a hollow space there between. The method according to this embodiment comprises sensing, by a tap motion sensor, a first tap motion input applied at the housing or a human interface device disposed on or with an outer surface of the wrist-mounted exercise monitor. The method continues with the transmission of a tap motion input signal, correlated to the first tap motion input sensed by the tap motion sensor, to a processor disposed within the wrist-mounted exercise monitor.

The processor, executing program code, controls output to the human interface device and enables a rotational motion sensor. The processor executing program code presents a user interface at the human interface device that has a menu carousel in a default state, the default state including the presentation of one or more active functions. The rotational motion sensor is operative to sense a direction and/or magnitude of a rotational motion about a rotational axis perpendicular to the plane defined by the housing and the strap and running through a point centrally located within the hollow space at the wrist-mounted exercise monitor. More specifically, the rotational motion sensor transmits a rotational motion signal to the processor that is correlated to the direction and/or magnitude of the rotational motion sensed at the rotational motion sensor. Further, the method comprises interpreting, by the processor executing program code, the rotational motion input signal to modify one or more data values associated with one or more active functions that the human interface device presents.

Continuing with this aspect of present embodiment, the method comprises sensing, by the tap motion sensor, a second tap motion input applied to human interface device or the housing. In response, the processor executes program code to accept the one or more data values associated with the one or more active functions presently displayed at the human interface device. Executing program code further instructs the processor to update the data carousel for the display of one or more subset active commands. According to one embodiment, the processor interprets rotational motion input to present newly displayed and/or previously displayed active functions and/or data values at the menu carousel.

In accordance with another embodiment, the invention is directed towards a control system for motion-based input control is provided. The system comprises a housing having an upper surface and a lower surface and a computing device disposed at least partially within the housing, in which the computing device includes a processor, a memory, and a human interface device. For example, the human interface device can be disposed at least partially on or within the upper surface of the housing. In one or more embodiments, the system comprises a plurality of flexible straps joined to the housing at a distal end, thereby forming an integral part of the housing, each of the plurality of flexible straps having a proximate end, in which the proximate end of each of the plurality of flexible straps can be removably coupled to define a closed loop having a hollow space there between. In embodiments in which the system comprises flexible straps, the system further comprises one or more interconnecting components used to couple the proximate end of each of the plurality of flexible straps in a removable manner. For example, the one or more interconnecting components is selected from the set of interconnecting components including comprise buckles, latches, locks and hook and loop fasteners.

Continuing with the present embodiment, the system comprises a user interface that is provided for presentation on the human interface device and under control of the processor, in which the user interface comprises a menu of function commands arranged as a data carousel, which may be continuous or bounded, and in which the one or more of the function commands presently displayed are active commands. The system further comprises a tap motion sensor configured to sense a tap motion input applied at the display or housing and configured to transmit a tap motion input signal to the processor that is correlated with the tap motion input. The processor provides instructions upon receiving the tap motion input signal to enable the display.

Additionally, the system comprises a rotational motion sensor configured to sense rotational motion input in the form of rotation about an axis running through a point centrally located within the hollow space and transmit a rotational motion input signal to the processor, the rotational motion input signal correlated with direction and magnitude of the rotational motion input. In one or more embodiments in which the display is enabled upon receiving the rotational motion input signal, the processor executes program code to modify one or more data values associated with the active commands. Similarly, upon receiving the tap motion input signal, the processor executes program code to accept the one or more data values associated with the active command(s). For example, upon receiving tap motion input, the processor activates a user interface function.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a side isometric view illustrating a wrist mounted system for providing exercise monitoring according to one or more embodiments of the present invention;

FIG. 2 presents a block diagram illustrating the logical arrangement of hardware components in a system for providing motion control according to one or more embodiments of the present invention;

FIG. 3 presents a flow diagram illustrating a method for motion-based input control to a system by one or more sensors according to one or more embodiments of the present invention;

FIG. 4 presents a block diagram illustrating an alternative logical arrangement of hardware components in a system for providing motion control according to one or more embodiments of the present invention;

FIG. 5 presents a flow diagram illustrating an alternative method for motion-based input control to a system by one or more motion sensors according to one or more embodiments of the present invention;

FIG. 6 presents a flow diagram illustrating an additional alternative method for motion-based input control to a system by one or more motion sensors according to one or more embodiments of the present invention; and

FIG. 7 presents a flow diagram illustrating a continuation of the additional alternative method for motion-based input control to a system by one or more motion sensors according to one or more embodiments of the present invention.

### DETAILED DESCRIPTION OF THE INVENTION

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. Similarly, the phrase “one or more embodiments” as used herein does not necessarily refer to the same embodiment and the phrase “at least one embodiment” as used herein does not necessarily refer to a different embodiment. The intention is, for example, that claimed subject matter include combinations of example embodiments in whole or in part.

By way of overview and introduction, one or more embodiments of the present invention provide intuitive control systems and methods comprising electronic hardware components for receiving motion input (e.g., tap motion, rotational motion) to control a processor responsible for executing program code and process data acquired from the electronic hardware to determine whether particular gestures were performed, as well as instruct the hardware to modify a user interface correspondingly. This is a specific improvement to the art of motion-control based systems, in which human gestures must be interpreted by computing technology in order to solve a particular computing problem, namely converting human movement into computer input and corresponding output.

Aspects of the invention can be appreciated in regard to the following discussion which is provided at times in the context of a wrist mounted electronic device, in accordance with one or more exemplary embodiments. More generally, the invention can be implanted in any device known in the art in which motion sensing feedback can be processed to interact with a user interface, which can be displayed at an electronic device as in the disclosed embodiments. It will be appreciated, however, that the invention is not limited to the confines of the wrist device arts, but rather can be employed in devices having one or more motion sensors (e.g., gyroscopic sensors, accelerometers) including at least one system configured to receive input through a rotational motion sensor and a tap motion sensor. For example, in one or more embodiments, the invention can be employed around a bicep, leg, or torso.

The wrist mounted electronic device example is provided as one arrangement in which user rotational motion controls the user interface in particular ways, whereas tap motion controls the user interface in additional ways. In particular, the one or more sensors can sense the direction and magnitude of rotational motion input and transmit a rotational motion input signal that is correlated with such input to a processor. For example, if a user applies a rotational angular velocity to the system in a particular direction, an accelerometer and/or gyroscopic sensor(s) can sense the applied force and generate the correlated input signal to the processor, which in turn, instructs a user interface to perform a command corresponding to the rotational motion input (e.g., scroll through options provided a carousel menu at a faster or slower speed depending on the rotational angular velocity).

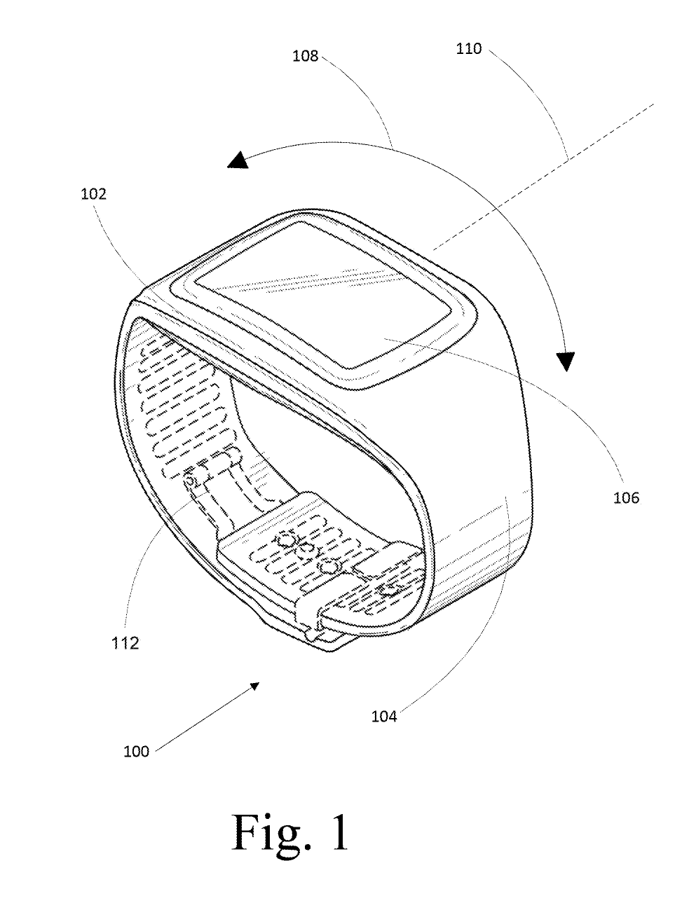

With reference now to FIG. 1, the illustration presents a side isometric view of an exemplary wrist mounted system for providing exercise monitoring. The exemplary wrist mounted system 100 can be any type of wrist mounted device including, but not limited to, an exercise monitor or device capable of monitoring physiological parameters as is known in the art. In one or more embodiments, the system 100 is designed to be employed underwater. To this point, the components described hereafter can be waterproof, such that the system is capable of functioning during aquatic exercise, e.g., swimming, as well as employ watertight seals along any points on the device housing 102 where disparate pieces join together. The system 100 comprises a housing 102 having an upper surface and a lower surface, such housing being joined at its distal ends with a flexible strap 104. The housing 102 and strap 104 can be formed out of materials suitable for wearing on a wrist, such as rubber, cloth, metal, or various combinations thereof.

In one or more embodiments, the strap 104 is formed as an integral part of the housing 102. At each end of the strap 104 is an interconnecting component 112 that can couple an end of a given strap in a removable manner so as to define a closed loop having a hollow space there between. For example, the interconnecting component 112 can comprise adjustable buckles, latches, locks, hook and loop fasteners or other mating components known to those of ordinary skill in the art that a user can manipulate to change the size of the loop created when the ends of the strap 104 are coupled in order to, for example, accommodate different sized wrists. The housing 102 further comprises a computing device or components at least partially disposed within the housing 102, such computing device comprising a processor, a memory, accelerometer(s), gyroscope(s) and a display 106.

In one or more embodiments, the housing 102 is configured to receive tap motion input. The display 106 can be of any type suitable for receiving tap motion input, as is known in the art. For example, the display 106 can be an organic light-emitting diode (“OLED”), light-emitting diode (“LED”), LED matrix or similar display types that are suitable to be disposed in a housing that can be accommodated on the body of a user. In one or more embodiments, the display 106 is waterproof. For example, the display 106 can include a water resistant or other protective film, glass, resin, epoxy or other material covering over the display.

In one or more embodiments, the system 100 is a wrist mounted electronic device, and, as such, is rotatable 108 about a rotational axis 110 that is substantially perpendicular to the plane defined by the housing 102 and strap 104. For example, a system 100 mounted on a wrist of a user has a rotational axis 110 parallel to the forearm of the user. In this way, if a user rotates the system 100 along the axis 110 in one of two rotational directions 108, such motion is interpreted as input that the processor of the system 100 processes, thereby allowing the user to interact with user interface elements presented at the display 106.

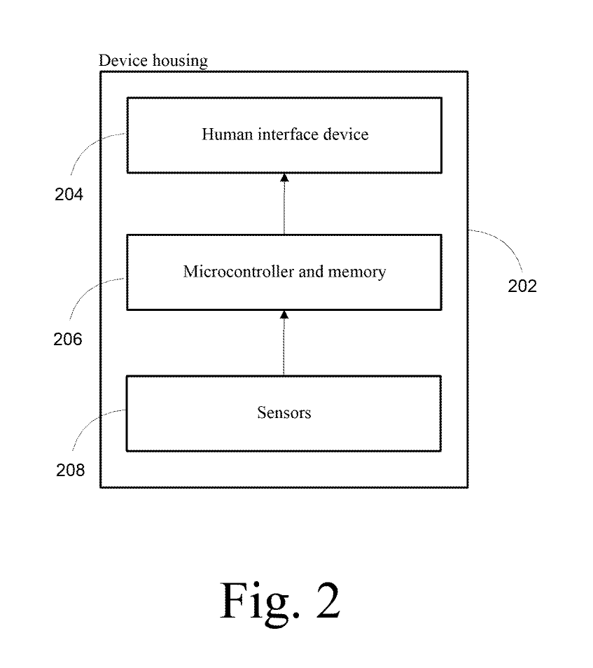

Claimed subject matter covers a wide range of potential variations in user computing devices beyond wrist mounted devices, e.g., smartwatches or exercise monitors. The control system as described herein, which comprises electronic hardware and associated software to accomplish the tap motion input and rotational motion input control can be applied in a variety of devices. As such, with reference now to FIG. 2, the drawing presents a high-level diagram illustrating an exemplary configuration of a control system 202 for an electronic device in accordance with one or more embodiments of the present invention. For example, the control system 202 can be located within a device housing, e.g., housing 102. In one or more of the embodiments provided and described herein, however, the control system 202 is not required to be within housing and can be located at any position suitable to measure the relevant motion input.

The control system 202 comprises a human interface device (“HID”) 204, a microcontroller 206, and one or more sensors 208. The housing can be any suitable type for receiving tap motion and rotational motion input, so long as the sensors 208 are capable of sensing motion input imparted at the housing. The one or more sensors 208 can comprise any number of accelerometers and/or gyroscopic sensors capable of sensing tap input and rotational motion input. In one or more embodiments, the sensors 208 are micro-electromechanical sensors (“MEMS”), as are known in the art, which covert measured mechanical signals (e.g., motion) into electrical signals that can be transmitted to the microcontroller 206 for further processing and response.

The microcontroller 206 is operatively connected to various hardware and software components that serve to enable operation of the systems and methods described herein, comprising a processor and one or more memories embedded into or forming a part of the microcontroller structure. The microcontroller 206 serves to execute instructions contained in program code, which instruct the microcontroller 206 to perform various operations relating to the receipt of tap motion input, rotational motion input, and processing such input to interact with a user interface (“UI”) having a variety of controls, menu functions, and commands. For example, the UI can relate to the monitoring of physiological parameters of a user, exercise programs, and other watch functions, but the UI is not limited to physiological parameters. The processor of the microcontroller 206 can comprise a single processor, multiple discrete processors, a multi-core processor, or other type of processor(s) known to those of skill in the art, depending on the particular embodiment.

In accordance with one or more embodiments, the microcontroller 206 comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”) or other memory types. Such memories can be fixed or removable, as is known to those of ordinary skill in the art, such as through the use of removable media cards or modules. In one or more embodiments, the memory of the microcontroller 206 provides for storage of application program and data files at the control system 202. One or more memories provide program code that the control system 202 reads and executes at startup or initialization, which may instruct the microcontroller 206 as to specific program code from RAM to load at startup.

The HID 204 can be any device capable of receiving input and delivering output in some form for presentation to a user. For example, the HID 204 can comprise a display, an audio emitter, a haptic technological device, or other HIDs as is known in the art. In one or more embodiments, the HID 204 receives processed motion input from the microcontroller 206 and outputs it onto a display through a UI or user experience presentation (“UX”).

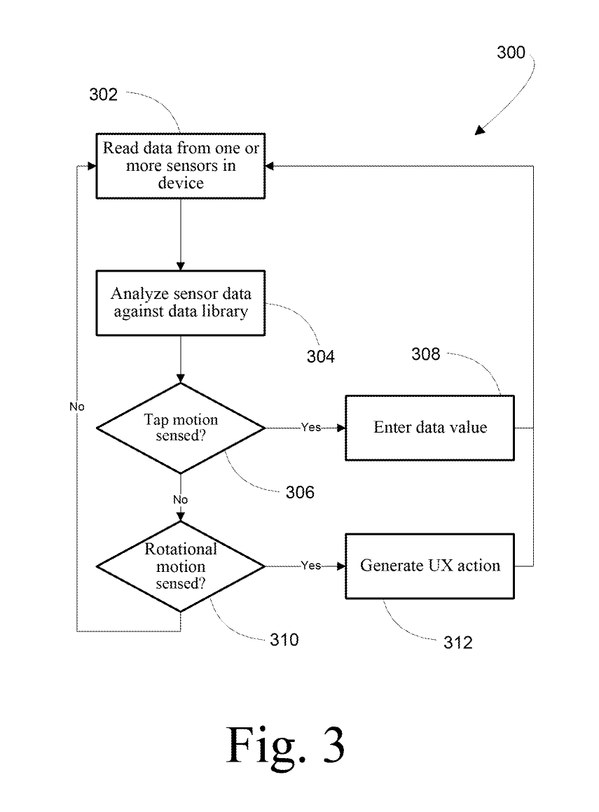

FIG. 3 is a flow diagram illustrating an exemplary method 300 for motion-based input control to a system by actuating one or more motion sensors in accordance with one embodiment of the present invention. In accordance with the embodiment of FIG. 3, a user interacts with a control system by providing tap motion input and rotational motion input through one or more motion sensors (e.g., sensor 208), such as accelerometers and/or gyroscopic sensors. The one or more sensors transmit an input signal correlated with the direction and/or magnitude of the motion input to a processor for downstream analysis and processing.

The flow begins at step 302, in which a microcontroller (e.g., microcontroller 206) reads sensor data transmitted by one or more sensors. For example, the data can be a motion input signal correlated with sensed motion. At step 304, the microcontroller analyzes sensor data against a data library. In one or more embodiments, the data library includes criteria for determining whether tap or rotation gestures have been performed at the control system.

At step 306, the microcontroller determines whether a tap motion has been sensed. For example, a tap motion can be sensed at a housing or other component at an outer surface of the control system (e.g., a HID 204 such as a display) of the control system. If the microcontroller determines a tap motion has been sensed, the microcontroller enters a data value, step 308. For example, the microcontroller memory saves the data value that was displayed at the HID or performs UI navigation at the HID. At that point, the flow branches to step 302 and continues reading data from the sensors. If the microcontroller determines no tap motion has been sensed, the microcontroller determines whether rotational motion has been sensed, step 310. If rotational motion is sensed, the microcontroller instructs the HID to generate UX action, step 312. For example, a carousel having one or more active commands and/or options can scroll to change the active commands and/or options displayed at the HID. At that point, the flow branches to step 302 and continues reading data from the sensors. If no rotational motion is sensed, program flow branches to step 302 and continues reading data from the sensors.

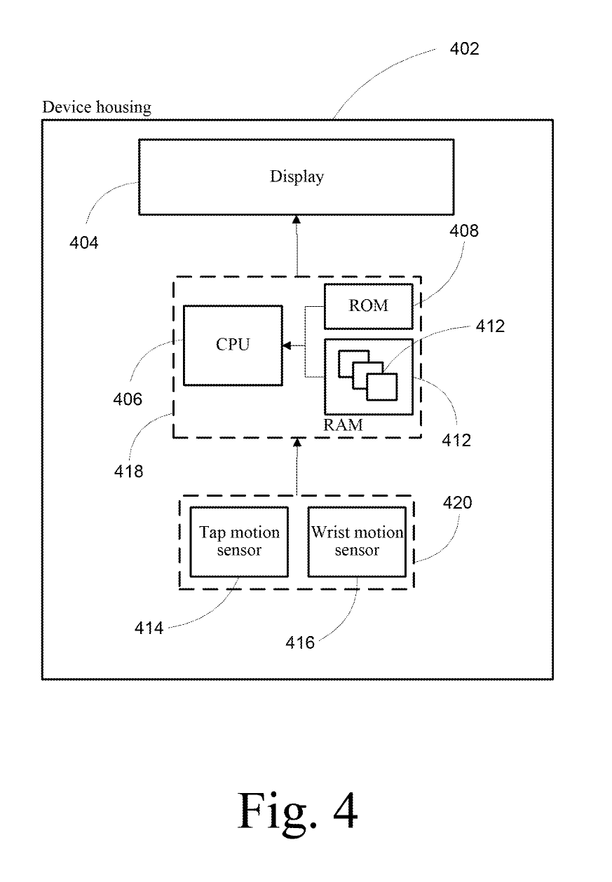

With reference now to FIG. 4, the drawing presents a high-level diagram illustrating an exemplary configuration of a control system 402 for an electronic device in accordance with one embodiment of the present invention, such as wrist mounted system 100. For example, the control system 402 can be located within housing 102. In one or more of the embodiments provided and described herein, however, the control system 402 is not required to be within housing 102 and can be located at any position suitable to measure the relevant motion input.

The control system 402 includes a display 404 configured to display a user interface (“UI”) for user interaction with input controls, menu functions, and the like. The display 404 or the housing (e.g., housing 102) can function as an input/output device for providing input to the control system 402 generated by the receipt of tap input from the user. Accordingly, in one or more embodiments the display 404 is a touch screen capable of receiving tap motion input at the display. For example, the touch screen may be a resistive touch input panel, which is activated with a stylus or a finger, or a capacitive input panel that is capable of multi-touch activation by one or more simultaneous finger touches. The capacitive panel is capable of distinguishing between two or more touches and is capable of providing inputs derived from those touches to the control system 402.

The control system 402 further comprises a microcontroller 418, the microcontroller having a processor 406 that is operatively connected to various hardware and software components that serve to enable operation of the systems and methods described herein. The processor 406 serves to execute instructions contained in program code, which instruct the processor 406 to perform various operations relating to the receipt of tap motion input, rotational motion input, and processing such input to interact with a UI having a variety of controls, menu functions, and commands. For example, the UI can relate to the monitoring of physiological parameters of a user, exercise programs, and other watch functions, but the UI is not limited to physiological parameters. The processor 406 can comprise a single processor, multiple discrete processors, a multi-core processor, or other type of processor(s) known to those of skill in the art, depending on the particular embodiment.

In accordance with one or more embodiments, the microcontroller 418 comprises one or more volatile and non-volatile memories, such as Read Only Memory (“ROM”) 408, Random Access Memory (“RAM”) 410, Electrically Erasable Programmable Read-Only Memory (“EEPROM”), Phase Change Memory (“PCM”) or other memory types. Such memories can be fixed or removable, as is known to those of ordinary skill in the art, such as through the use of removable SD media. In one or more embodiments the ROM 408 and RAM 410 are embedded into or otherwise form a part of the microcontroller 418 structure. The microcontroller 418 specifically comprises a volatile randomly accessible memory structure 410 for the storage of application program code, which can be a hard disk drive, flash memory device, electronically programmable erasable memory device, DIMM chip(s), etc. The volatile randomly accessible memory structure 410 provides for storage of application program and data files 412 at the control system 402. The persistent storage device can also be fixed or removable, as well as local to the client device or remote, for example, a cloud based storage device, or any combination of the foregoing. One or more non-volatile ROM memories provide program code that the control system 402 reads and executes at startup or initialization, which may instruct the processor 406 as to specific program code from RAM 410 to load at startup.

The processor 406 is programmed to recognize tap motion input as a result of tapping the display 404 or the housing and rotational motion (e.g., specific wrist motion patterns). In accordance with one or more embodiments the present invention, the control system 402 includes a tap motion sensor 414 and a rotational motion sensor 416. Although reference is made to individual tap motion sensor 414 and rotational motion sensor 416, embodiments of the invention are not limited to separate or discrete sensors, as in one or more embodiments, the tap motion sensor 414 and rotational motion sensor 416 can be integrated into a single MEMS sensor 420. Broadly, the sensors referenced herein can include any number and any type of sensors, in any arrangement that is suitable for measuring the desired motion input. For example, the MEMS sensor 420 can comprise one or more accelerometers and/or gyroscopic sensors.

The tap motion sensor 414 can be any sensor known in the art that can be operatively configured by the processor 406 to sense tap motion input applied at the display 404 and transmit a tap motion input signal correlated with the tap motion input to the processor 406. For example, tap motion sensor 414 can include capacitive sensors or other force sensing technologies. In one or more embodiments, the tap motion sensor 414 maintains persistent activation so long as there is power being supplied to the control system 402. When the processor 406 receives the tap motion input signal from the tap motion sensor 414, the processor provides instructions to the display screen 404. For example, the tap motion input can enable the display screen 404, interact with a UI element presently displayed, and/or activate the rotational motion sensor 416.

Unlike the tap motion sensor 414, the rotational motion sensor 416 is not always active according to certain embodiments, but rather activates when the processor 406 instructs it to activate, which may be in response to or as a result of the receipt of tap motion input. When active, the rotational motion sensor 416 is operatively configured to sense rotational motion about a rotational axis and, in response to rotational motion, send a rotational motion input signal correlated with the rotational motion input to the processor 406. In one or more embodiments, the rotational motion sensor 416 is disposed within the housing to sense rotation about an axis running through a point centrally located within a hollow space below a lower surface of the control system 402. In this way, the rotational axis is effected generally parallel to the arm of a user. For example, the rotational axis can be rotational axis 110. If the rotational motion sensor 416 is active and senses rotational motion, the sensor transmits a rotational motion input signal to the processor 406 that is correlated with the direction and magnitude of the rotational motion. In response, the processor 406 executes program code to issue commands to one or more UI elements. For example, a carousel menu displayed at the UI can be instructed to scroll menu options, select menu options, modify menu or option parameters, modify or accept data values, or other common input actions.

In one or more embodiments, inclusive of or in addition to the tap motion sensor 414 and the rotational motion sensor 416, one or more physiological parameter sensors can be included as part of the control system 402. For example, the control system 402 can comprise physiological parameter sensors to measure exercise programs, goals, types of workouts, distance traveled, speed, pace or stride, duration of activity, heart rate, number of calories burned, blood pressure, heart rate zones, etc., as well as standard watch functions, such as time, date and stopwatch.

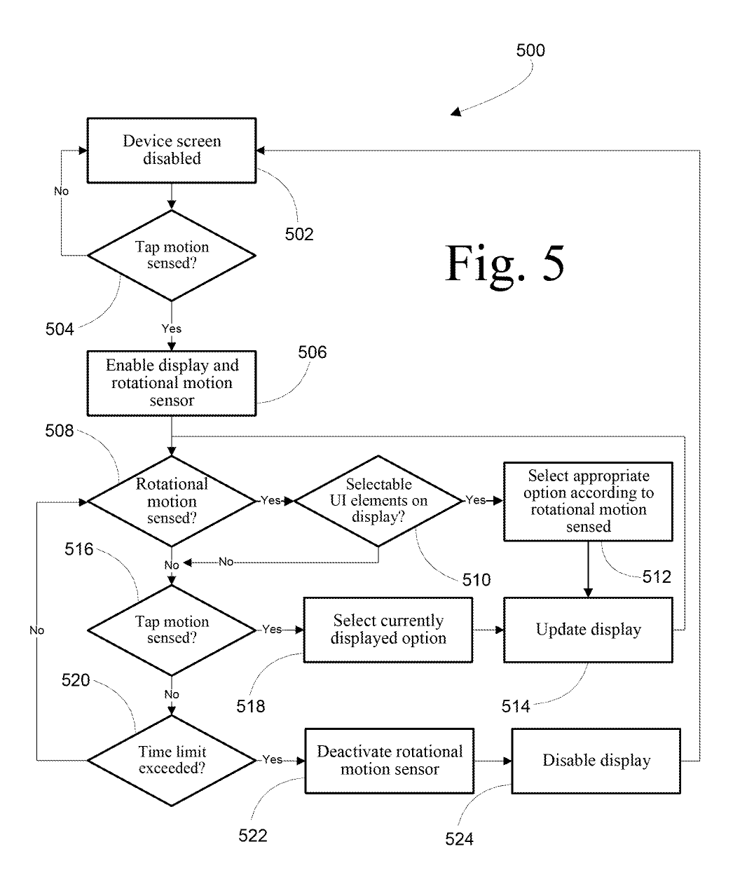

FIG. 5 is a flow diagram illustrating an exemplary method 500 for motion-based input control to a system by actuating one or more motion sensors is provided in accordance with one embodiment of the present invention. In accordance with the embodiment of FIG. 5, a user interacts with a control system by providing tap motion input through a tap motion sensor (e.g., tap motion sensor 414) and rotational motion input through a rotational motion sensor (e.g., rotational motion sensor 416). The tap motion sensor and/or the rotational motion sensor transmit an input signal correlated with the direction and/or magnitude of the motion input to a processor for downstream analysis and processing. In one or more embodiments, the tap motion input and rotational motion input are provided through a single sensor (e.g., MEMS sensor 420). A human interface device (e.g., HID 204, display 404) or a control system housing (e.g., housing 102) can function as an input/output device for providing input to the control system generated by the receipt of motion input from the user.

The method 500 begins at step 502, in which a display screen within the control system housing at the control system is disabled. The control system housing has a tap motion sensor capable of receiving tap motion input such as taps or presses, and both touch and other non-touch screens are contemplated as falling within the scope of the display as described herein. At step 504, a processor determines if input that the tap motion sensor receives is indicative of sensing a tap motion. For example, the tap motion sensor can sense tap motion input and transmit a tap motion input signal to the processor, such as for storage or further downstream processing. If the tap motion sensor does not receive any tap motion input, program flow loops to step 502 and the display screen remains disabled, which according to some embodiments comprises the presentation of a subset of information on the display, e.g., a lock screen. If the tap motion sensor receives a signal indicating a tap motion has been sensed, the processor enables both the display and a rotational motion sensor, step 506.

Continuing with reference to FIG. 3, at step 508, the processor determines whether rotational motion has been sensed. For example, the rotational motion sensor can sense rotational motion and transmit a corresponding rotational motion input signal to the processor. In one or more embodiments, the direction and/or magnitude of the rotational motion is measured, such as, for example, the wrist motion of a user in a measurable direction (e.g., direction 108). At step 310, the processor determines whether there are selectable UI elements presented on the display. For example, UI elements can comprise a carousel menu of function commands. If the display is enabled, but there are no selectable user options (e.g., a time screen is displayed instead of menu options or data selection options), the processor displays a subset screen or subset menu options. In this case, when the rotational motion is sensed, the processor may or may not change the screen.

If the processor is presenting selectable UI elements on the display, the processor executes program code to select an appropriate option according to the direction and/or magnitude of the rotational motion input sensed, step 512. At step 514, the processor instructs the display to update the menu options and/or active functions accordingly. For example, if an active function is displayed and the processor receives rotational motion input signals, the UI response is to scroll through a carousel menu of active functions, displaying the next or previous option(s) according to the direction of the rotational motion input signal or in the reverse order, with the currently active menu functions being sequentially displayed on the display.

Where the processor determines either that no rotational motion is currently sensed or that rotational motion has been sensed but there are no selectable UI elements presently displayed, however, the processor determines whether tap motion has been sensed at step 516. If tap motion is sensed, the processor executes program code to select the currently displayed option at step 518. Program flow continues with the processor updating the display, step 514. For example, if a tap motion input on the display is sensed by the tap motion sensor, the currently active menu option on the screen is accepted and the processor displays subset or superset options. Active options may include any number of data inputs related or unrelated to the wearer, e.g., the weight, height, or age of the wearer. In one or more embodiments, if rotational motion is also sensed at this point, the processor can execute program code to increment or decrement the displayed values of the active option or scroll through a carousel range of choices related to the given option, depending upon the direction of motion that the wearer provides, such as clockwise or counter clockwise. A user may tap the display when the processor presents the correct value on the display to confirm a selection.

In one or more embodiments, optionally included among the function commands that the data carousel presents is a communications link to a smartphone or tablet for programming, which can be used for inputting additional function commands, for retrieving and storing user specific exercise data, such as distance traveled, speed/pace, duration of activity, heart rate, calories burned, blood pressure, and heart rate zones, as well as for inputting the device settings and user specific data such as weight, height, age and other user parameters.

Where the processor does not receive any tap motion signal, step 516, program flow continues with the processor determining whether a predetermined time limit has been exceeded, step 520. A time limit can be set in program code in order to enhance power efficiency by turning off the system when it is not presently in use. If the time limit has not exceeded, program flow branches back to step 508, with the processor and/or sensors awaiting further motion input. If the processor determines that a time limit has been exceeded, the processor instructs the rotational motion sensor to deactivate, power down or otherwise enter a low power consumption state, step 522, as well as disables the display, step 524, with program flow looping back to step 502. In one or more embodiments, a carousel of menu commands can include among the function commands an option to turn off the device, which when accepted by sensing user tap motion input and transmitting a tap motion signal to the processor, causes the processor to disable the display and the rotational motion sensor.

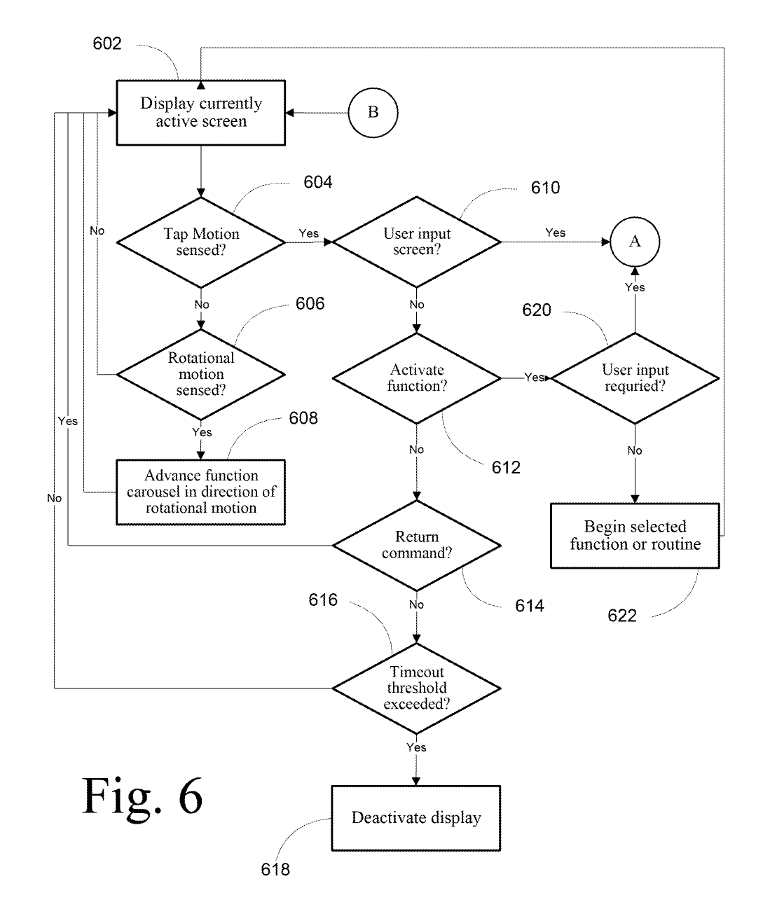

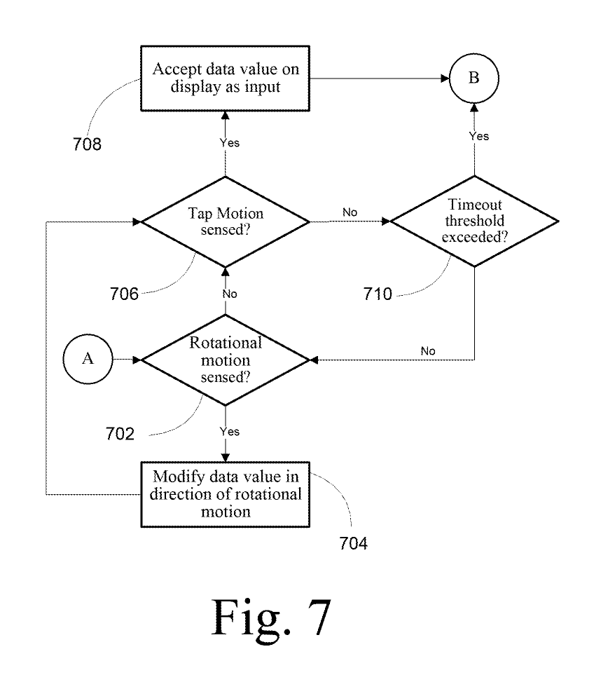

With reference now to FIGS. 6 and 7, the diagrams present program flow illustrating an alternative exemplary method for motion-based input control to a system by one or more motion sensors in accordance with embodiments of the present invention. The method according to the present embodiment incorporates tap and rotational motion input at an active display to navigate and interact with active functions displayed on the UI. The method begins at step 602, in which an active screen is currently displayed at the display. At step 604, a processor determines whether a tap motion has been sensed. If no tap motion is sensed, the processor (where as used in conjunction with FIGS. 4 and 5 can also comprise the use of tap and rotational motion sensors) determines whether rotational motion is sensed, step 606. If no rotational motion is sensed, program flow loops to step 602. If rotational motion is sensed, the processor advances the active element or entry in a data or function carousel in the direction of the rotational motion, step 608. For example, if clockwise rotational motion is sensed, the carousel steps to the next function, but if counter-clockwise rotational motion is sensed the carousel steps to the previous function. Program flow loops back to step 602 and the processor determines whether further motion is sensed.

Where the processor determines that tap motion has been sensed, step 604, program flow branches to step 610 with the processor executing program code to determine whether the active function at the UI is a user input screen. For example, a user input screen is a UI element through which the user can provide input to modify data values stored on the system. In this way, a user can adjust settings to various data values. If the processor determines that no user input screen is displayed, step 610, the processor determines whether an active function can be activated as a result of the tap motion input, step 612. For example, an active function can be a binary prompt (e.g., yes/no), a confirm prompt, a link to launch an app, or other functions. If an active function is not displayed at the UI, the processor executes program code to determine whether a return command has been activated, step 614. For example, a return command can be a UI element that returns a user to different menu layer, such as a main layer, a subset layer, or a superset layer. If a return command is selected by the tap motion input, the method loops to step 602 and displays a newly selected active screen. Though, if the processor determines that no return command has been selected, step 614, the processor determines whether a timeout threshold has been exceeded, step 616. A timeout threshold can be, for example, several seconds or other predetermined length depending on a desired effect or energy efficiency. If the processor determines that the timeout threshold has not been exceeded, the method loops to step 602. If the timeout threshold has been exceeded, the processor instructs the display to deactivate, step 618, and thereafter the method terminates.

Notwithstanding those steps, if the tap motion sensed, step 604, is determined by the processor to activate a function, step 612, the method program flow is directed towards step 620 in which the processor determines whether user input is required. If the processor determines the function does not require user input, the processor executes program code to begin the selected function or routine, step 622. For example, functions such as starting a stop watch, or sensing a heart rate do not require more user input than a selection of the function.

If the processor determines a tap motion results in loading a user input screen, step 610, or if user input is required, step 620, program flow continues with reference to FIG. 5, with the method branches to step 702, with the processor determining whether rotational motion has been sensed. If rotational motion is sensed, the processor modifies the data value associated with the input, step 704. For example, the data value can be modified in accordance with the direction and magnitude of the rotational motion. In this way, data values can be incremented or decremented. According to some embodiments, the processor uses rotational magnitude values to determine the rate of change of values that it presents on the display. At this point, or if no rotational motion is sensed at step 702, program flow is directed to step 706, in which the processor execute program code to determine whether tap motion is sensed. If tap motion is sensed, the method continues with the processor accepting the data value on the display as input, step 708, and program flow returning to step 602. If no tap motion is sensed, however, the processor determines whether a timeout threshold has been exceeded. If the timeout threshold has not been exceeded, program flow returns to step 702, with the processor checking for rotational motion. If the threshold has been exceeded, step 710, program flow returns to step 602.

FIGS. 1 through 7 are conceptual illustrations allowing for an explanation of the present invention. Those of skill in the art should understand that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software embodiments, computer software (e.g., programs or other instructions) and/or data is stored on a machine-readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

1. A method for motion-based input control to a wrist-mounted exercise monitor having one or more motion sensors disposed within a housing, the housing joined coplanar to a flexible strap having a first end and a second end that removably couple to define a closed loop having a hollow space there between, the method comprising:
sensing, by a tap motion sensor, a first tap motion input applied at the housing or a human interface device disposed on an outer surface of the wrist-mounted exercise monitor;
transmitting a tap motion input signal that is correlated to the first tap motion input sensed by the tap motion sensor to a processor disposed within the wrist-mounted exercise monitor;
enabling the human interface device and enabling a rotational motion sensor;
presenting at the human interface device, by the processor executing code, a user interface having a menu carousel in a default state, the default state having one or more active functions presented;
sensing, by the rotational motion sensor, a direction and/or magnitude of a rotational motion about a rotational axis perpendicular to the plane defined by the housing and the strap and running through a point centrally located within the hollow space at the wrist-mounted exercise monitor;
transmitting a rotational motion signal to the processor that is correlated to the direction and/or magnitude of the rotational motion sensed at the rotational motion sensor;
interpreting, by the processor executing program code, the rotational motion input signal to modify one or more data values associated with the one or more active functions.

2. The method according to claim 1, comprising:
sensing, by the tap motion sensor, a second tap motion input applied to human interface device or the housing;
accepting, by the processor executing program code, the one or more data values associated with the one or more active functions presently displayed at the human interface device; and
updating, by the processor, the data carousel to display one or more subset active commands.

3. The method according to claim 1, wherein the processor interprets rotational motion input to present newly displayed and/or previously displayed active functions at the menu carousel.

4. A control system for motion-based input control, the system comprising:
a housing having an upper surface and a lower surface;
a computing device disposed at least partially within the housing, wherein the computing device includes a processor, a memory, and a human interface device;
a plurality of flexible straps joined to the housing at a distal end, thereby forming an integral part of the housing, each of the plurality of flexible straps having a proximate end, wherein the proximate end of each of the plurality of flexible straps can be removably coupled to define a closed loop having a hollow space there between;
a user interface for presentation on the human interface device and under control of the processor, the user interface having a menu of function commands arranged as a continuous data carousel, wherein the one or more of the function commands presently displayed are active commands;
a tap motion sensor configured to sense a tap motion input applied at the human interface device or housing and transmit a tap motion input signal to the processor that is correlated with the tap motion input, wherein the processor provides instructions upon receiving the tap motion input signal to enable the human interface device; and
a rotational motion sensor configured to sense rotational motion input in the form of rotation about an axis running through a point centrally located within the hollow space and transmit a rotational motion input signal to the processor that is correlated with direction and magnitude of the rotational motion input,
wherein if the human interface device is enabled upon receiving the rotational motion input signal, the processor executes program code to modify one or more data values associated with the active commands and wherein upon receiving the tap motion input signal, the processor executes program code to accept the one or more data values associated with the active commands.

5. The system according to claim 4, wherein the human interface device is disposed at least partially on the upper surface of the housing.

6. The system according to claim 4, wherein the hollow space is suitable for a wrist.

7. The system according to claim 4, wherein upon receiving the tap motion input signal, the processor activates the rotational motion sensor.

8. The system according to claim 4, wherein upon receiving rotational motion input, the processor modifies a data value.

9. The system according to claim 4, wherein upon receiving tap motion input, the processor accepts a data value as input.

10. The system according to claim 4, wherein upon receiving tap motion input, the processor activates a user interface function.

11. The system according to claim 4, comprising one or more interconnecting components used to couple the proximate end of each of the plurality of flexible straps in a removable manner.

12. The system according to claim 11, wherein the one or more interconnecting components is selected from the set of interconnecting components including comprise buckles, latches, and locks.
